(19) United States
(12) Patent Application Publication
(10) Pub. No.: US 2007/0068308 A1
(43) Pub. Date: Mar. 29, 2007

(54) MEMS actuator

(76) Inventor: Dennis S. Greywall, Whitehouse Station, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/233,197

(22) Filed: Sep. 22, 2005

(51) Int. Cl. G05G 11/00

(52) U.S. Cl. 74/490.1

(57) ABSTRACT

A rigid actuator arm is an appendage of a moveable drive plate that is coupled across at least one end of each of two deformable spring bars that are anchored at their opposite end to a support structure that keeps the end of the moveable drive plate that is not coupled to the to the deformable spring bars from touching the substrate. The moveable drive plate mates with an opposing fixed drive plate so that applying a potential difference between the moveable drive plate and the fixed drive plate causes the moveable drive plate to move toward the fixed drive plate with a rotation type motion. The rigid actuator arm likewise rotates about an axis that is through the point of attachment of the rigid actuator to the moveable drive plate. Consequently, the opposite end of the rigid actuator arm moves as well, with an amplification of the rotation motion.

### TECHNICAL FIELD

This invention relates to micro-electromechanical systems (MEMS), and more particularly, to controllably rotating a beam.

### BACKGROUND OF THE INVENTION

It is desirable to employ a moveable plate for certain applications of micro-electromechanical systems (MEMS). Such moveable plates may operate similar to a rocker arm. When such plates are narrow in one dimension, they may more closely resemble a beam. One typical application of MEMS devices is optical communication, where a beam could be used to interrupt the passage of light, e.g., the beam operates as a shutter mechanism, or to controllably redirect light. More specifically, for some applications, it is desirable that the motion of the plate or beam be out of the plane of the substrate from which the beam was formed.

### SUMMARY OF THE INVENTION

I have recognized that a rigid actuator arm may be caused to rotate out of the plane of the substrate from which it is formed, with minimal other non rotation motion, in accordance with the principles of the invention, by having the rigid actuator arm be an appendage of a moveable drive plate that is coupled across at least one end of each of two deformable spring bars that are anchored at their opposite end. The deformable spring bars are anchored to a support structure so as to keep the end of the moveable drive plate that is not coupled to the to the deformable spring bars from touching the substrate. The opposite end of the support structure is coupled to the substrate.

The moveable drive plate mates with an opposing fixed drive plate in a manner such that when there is a potential difference between the moveable drive plate and the fixed drive plate the moveable drive plate moves toward the fixed drive plate with a rotation type motion. The motion of the moveable drive plate exerts a torque on the deformable spring bars, causing them to bend. Given that the rigid actuator arm is an appendage of the moveable drive plate, when the moveable drive plate rotates, the rigid actuator arm likewise rotates, essentially about an axis that is through the point of attachment of the rigid actuator to the moveable drive plate. Consequently, the opposite end of the rigid actuator arm moves as well, with an amplification of the rotation motion depending on the length of the rigid actuator arm. As a result, the end of the rigid actuator arm opposite the connection point may move above the plane of the top of the moveable drive plate, e.g., above the top surface of the substrate on which it is formed. The deformable spring bars provide a restoring force to return the moveable drive plate toward its rest position when the potential difference between the moveable drive plate and the fixed drive plate is reduced or eliminated.

Depending on whether the rigid actuator arm is on the same side or the opposite side of the moveable plate as is the stationary electrode determines whether the rotation is up or down with respect to the plane of the substrate.

The moveable drive plate and the fixed drive plate may, advantageously, form a so-called “torsional comb drive”. To this end, the drive plates may include comb “teeth”. Pedagogically, the rigid actuator arm may be thought of in some applications as an elongated version of a comb tooth.

Various shapes may be employed for the deformable spring bars, depending on the stiffness required for them. Typically, the softer the resulting deformable spring bars are, the lower the voltage that is required for any prescribed angle of rotation. However, softer springs may result in additional motion other than the desired rotation.

Advantageously, the rigid actuator arm may function as a shutter.

### BRIEF DESCRIPTION OF THE DRAWING

In the drawing:

FIG. 1 shows a top view of exemplary structure that can move a rigid actuator arm above the plane of the substrate on which it is formed, in accordance with the principles of the invention;

FIG. 2 shows a cross-section of the exemplary structure of FIG. 1 in its rest position;

FIG. 3 shows a cross-section of the exemplary structure of FIG. 1 in an energized state;

FIG. 4 shows a side perspective of the exemplary structure of FIG. 1;

FIG. 5 shows another exemplary structure, similar to the exemplary structure of FIG. 1 but in which the straight parallel deformable spring bars of FIG. 1 are replaced with curved springs;

FIG. 6 shows another exemplary structure similar to that of the exemplary structure of FIG. 1, but in which the straight parallel deformable spring bars are replaced with curved deformable springs and the wall of FIG. 1 is replaced with multiple walls;

FIG. 7 shows another exemplary structure similar to that of the exemplary structure of FIG. 1 but in which the rigid actuator arm moves into the plane of the substrate on which the structure;

FIG. 8 shows a cross-section of the structure of FIG. 7 in its rest state;

FIG. 9 shows a cross-section of the structure of FIG. 7 when it is in an energized state; and

FIG. 10 shows another exemplary structure similar to the structure of FIG. 1 but in which there are multiple rigid actuator arms that protrude from the moveable drive plate.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Unless otherwise explicitly specified herein, the drawings are not drawn to scale.

Additionally, unless otherwise explicitly specified herein, any lens shown and/or described herein is actually an optical system having the particular specified properties of that lens. Such an optical system may be implemented by a single lens element but is not necessarily limited thereto. Similarly, where a mirror is shown and/or described what is actually being shown and/or described is an optical system with the specified properties of such a mirror, which may be implemented by a single mirror element but is not necessarily limited to a single mirror element. This is because, as is well known in the art, various optical systems may provide the same functionality of a single lens element or mirror but in a superior way, e.g., with less distortion. Furthermore, as is well known in the art, the functionality of a curved mirror may be realized via a combination of lenses and mirrors and vice versa. Moreover, any arrangement of optical components that are performing a specified function, e.g., an imaging system, gratings, coated elements, and prisms, may be replaced by any other arrangement of optical components that perform the same specified function. Thus, unless otherwise explicitly specified here, all optical elements or systems that are capable of providing specific function within an overall embodiment disclosed herein are equivalent to one another for purposes of the present disclosure.

The term micro-electromechanical systems (MEMS) device as used herein is intended to mean an entire MEMS device or any portion thereof. Thus, if a portion of a MEMS device is inoperative, or if a portion of a MEMS device is occluded, such a MEMS device is nonetheless considered to be a MEMS device for purposes of the present disclosure.

In the description, identically numbered components within different ones of the FIGs. refer to the same components.

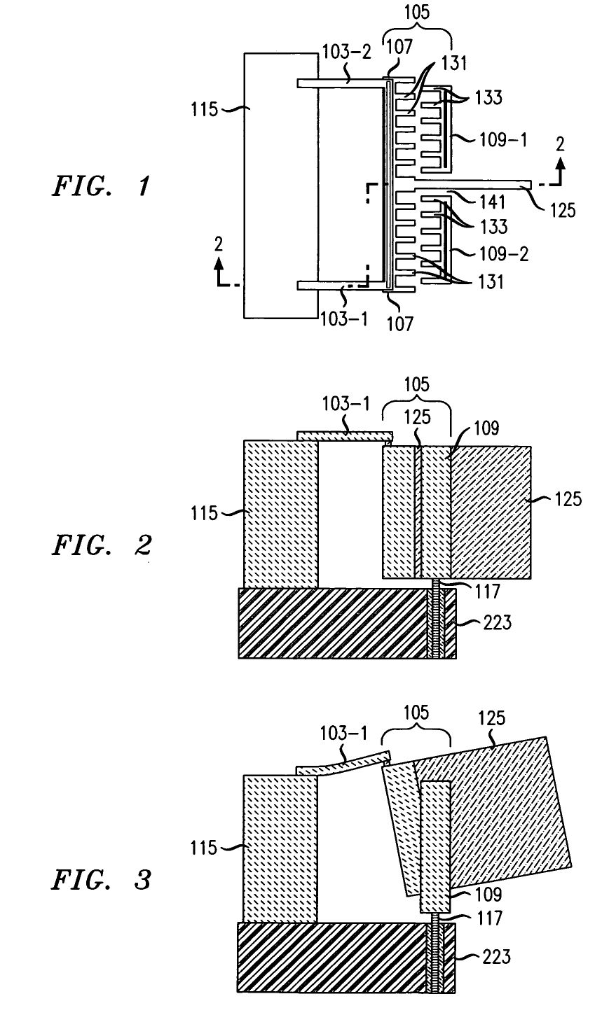

Shown in FIG. 1 is a top view of exemplary structure 100 which can move a rigid actuator arm above the plane of the substrate on which it is formed, in accordance with the principles of the invention. More specifically, structure 100 includes deformable spring bars 103, which includes deformable spring bars 103-1 and 103-2. Wall 115 supports deformable spring bars 103 and holds them offset from underlying substrate 223, which can be seen in FIG. 2. Note that FIG. 2 shows a cross-section of structure 100, and hence only one of spring bars 103, e.g., deformable spring bar 103-1, can be seen in FIG. 2. Furthermore, FIG. 2 shows structure 100 in its rest position.

As can be seen in FIG. 1, deformable spring bars 103 are parallel to each other. Furthermore, not only are spring bars 103 coupled to each other via wall 115, but they are also each coupled to the other at another point, e.g., at their ends opposite to wall 115, by moveable drive plate 107. Pedagogically at least, if not in fact, one can consider spring bars 103 and the top portion of moveable drive plate 107 to essentially form a single unified spring support for moveable drive plate 107.

Drive 105 is made up of moveable drive plate 107 and at least one fixed drive plate 109 mated therewith. Shown in FIG. 1 are two fixed drive plates, fixed drive plate 109-1 and fixed drive plate 109-2, collectively herein as fixed drive plates 109. Between fixed drive plates 109 is gap 141 through which rigid actuator arm 125 passes and in which rigid actuator arm may move up and down.

As shown in FIG. 2, fixed drive plates 109 may be coupled to a potential different than that to which moveable drive plate 107 is coupled. This is achieved by using a through-substrate connection. This connection has a conducting portion 117, through which the potential is supplied, and an electrical insulating portion 119, which is typically annular, that insulates the one of fixed drive plates 109 from substrate 225, and hence from moveable drive plate 107 and walls 115.

Note that in order to be able to distinguish in the FIGs. between rigid actuator arm 125 and moveable drive plate 107, as well as between rigid actuator arm 125 and fixed drive plates 109, rigid actuator arm 125 is shown with a hatching that is different that of both moveable drive plate 107 and fixed drive plates 109. However, those of ordinary skill in the art will readily recognize that although each of a) rigid actuator arm 125, b) moveable drive plate 107, and c) fixed drive plates 109, as well as deformable spring bars 103, may be made of different materials, preferably they are made of the same material, e.g., polysilicon. Furthermore, although reference numeral 125 appears twice in FIG. 2, both refer to the same single rigid actuator arm, and are merely pointing out its two visible portions, which would otherwise be difficult to see.

Preferably moveable drive plate 107 is grounded. Energizing, any of fixed drive plates 109, by applying a potential different than that of moveable drive plate 107, causes moveable drive plate 107 to move toward the energized one of plates 109. Like FIG. 2, FIG. 3 shows a cross-section of exemplary structure 100. However, FIG. 3 shows an example of the resulting motion of moveable drive plate 107 when fixed drive plates 109 are energized by applying a potential that is different relative to that of moveable drive plate 107. As can be seen in FIG. 3, when moveable drive plate 107 moves from its rest position toward fixed drive plates 109, each of deformable spring bars 103 is deformed simultaneously.

Rigid actuator arm 125 is essentially an appendage of a moveable drive plate 107. As a result, when moveable drive plate 107 rotates, rigid actuator arm 125 likewise rotates, essentially about an axis that is through the point of attachment of rigid actuator arm 125 to moveable drive plate 107. Consequently, the end of rigid actuator arm 125 opposite to its attachment point to moveable drive plate 107 moves as well. Thus, there is an amplification of the rotation motion, the magnitude of which depends on the length of rigid actuator arm 125. As a result, the end of rigid actuator arm 125 opposite to its point of connection to drive plate 107 moves out of the plane of substrate 225 and, depending on the implementation specifics may move above the top of the structures formed on substrate 223.

Deformable spring bars 103 provide a restoring force. When the potential difference between moveable drive plate 107 and fixed drive plates 109 is reduced, or eliminated, deformable spring bars 103 cause moveable drive plate 107 to move back toward its rest position, e.g., as shown in FIG. 2.

Although moveable drive plate 107 and fixed drive plates 109 may be plate electrodes, preferably they are, as shown in FIG. 1, so-called comb electrodes, i.e., they have comb projections 131 and 133, respectively. Thus, together, moveable drive plate 107 and fixed drive plate 109 form comb drive 105. Advantageously, since the force of a comb drive is linear with the square of the applied voltage, use of comb plates minimizes the likelihood of undesirable snapdown occurring. When comb electrodes are employed, rigid actuator arm 125 may be thought of as an overgrown comb projection of moveable drive plate 107.

Advantageously, exemplary structure 100 can move rigid actuator arm 125 out of the plane of substrate 223 (FIG. 2) on which it is formed, and can even reach above the highest structures formed on substrate 223. Thus, rigid actuator arm 125 may function as a shutter. Further advantageously, structure 100 may be operated with the relatively low voltages compatible with modern digital electronics.

One of ordinary skill in the art will readily recognize that rather than using a single wall 115, multiple wall sections, or even posts, could be used to individually support deformable spring bars 103.

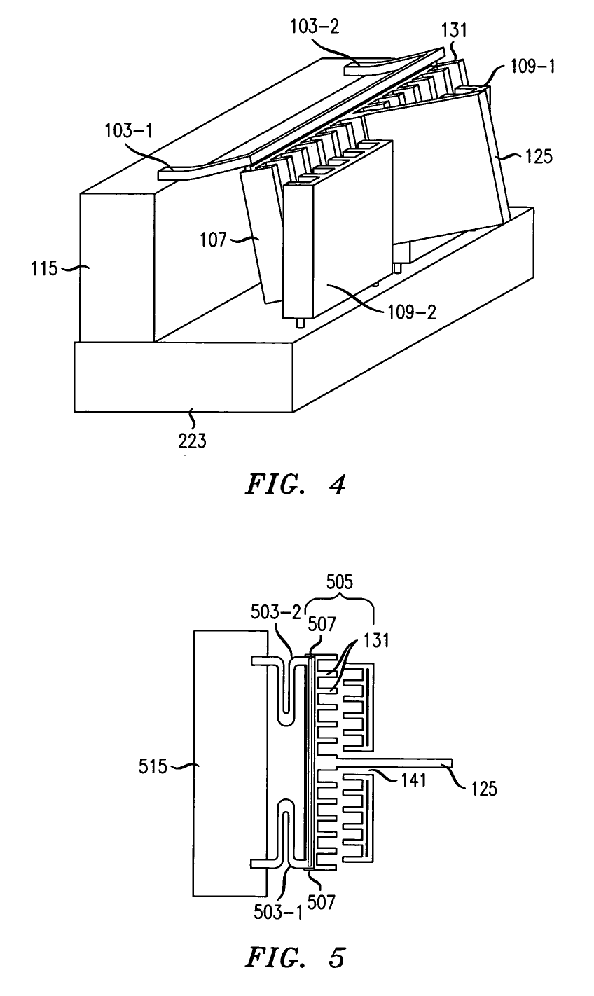

FIG. 4 shows a side perspective of exemplary structure 100.

Those of ordinary skill in the art will readily recognize that various shapes may be employed for the deformable spring bars, depending on the stiffness required for them. Typically, the softer the resulting deformable spring bars are, the lower the voltage that is required for any prescribed angle of rotation. However, softer springs may result in additional motion other than the desired rotation.

FIG. 5 shows exemplary structure 500, similar to exemplary structure 100 (FIG. 1), but in which straight parallel deformable spring bars 103 are replaced with curved springs 503 (FIG. 5). Curved deformable springs 503 perform the same function as straight parallel deformable spring bars 103, but their spring properties may be different. Those of ordinary skill in the art will readily recognize that various spring designs may be employed to achieve a desired spring resistance and restoration force. Structure 500 (FIG. 5) operates using the same principles as for structure 100 (FIG. 1).

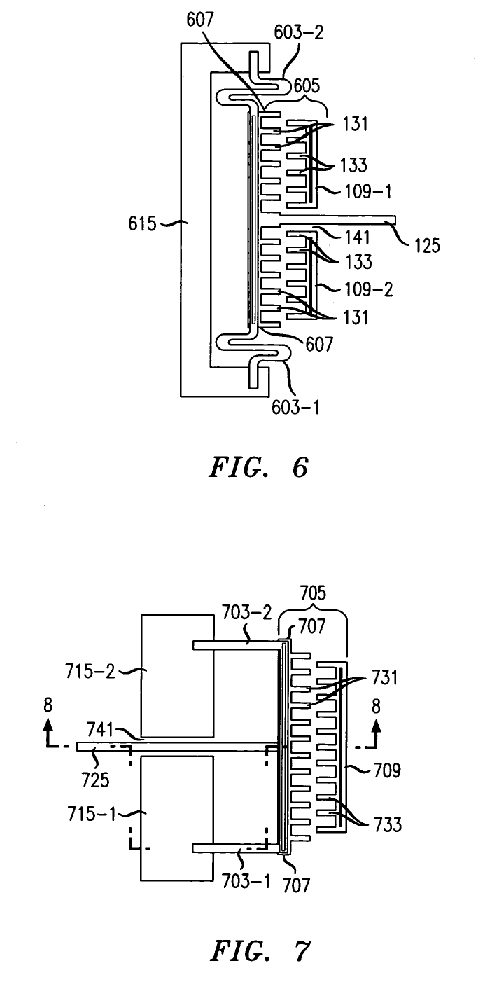

FIG. 6 shows exemplary structure 600, similar to exemplary structure 100 (FIG. 1), but in which straight parallel deformable spring bars 103 are replaced with curved deformable springs 603 (FIG. 6) and wall 115 (FIG. 1) is replaced by walls 615 (FIG. 6). The functions of curved deformable springs 603 and walls 615 are the same as that of deformable spring bars 103 (FIG. 1) and wall 115, namely, generally, to hold moveable drive plate 107 in its rest position when there is no potential difference, and to provide a restoring force. Those of ordinary skill in the art will readily recognize that curved deformable springs 603 may be replaced with springs having other shapes, even straight ones. Similarly, those of ordinary skill in the art will readily recognize that the different shaped wall and different points of attachments along those walls may be employed.

FIG. 7 shows exemplary structure 700, similar to structure 100 (FIG. 1) but in which rigid actuator arm 725 (FIG. 7) moves into the plane of the substrate on which structure 700 is mounted. To achieve this, rigid actuator arm 725 is formed or attached on the opposite side of moveable drive plate 707 as compared with the attachment of rigid actuator arm 125 (FIG. 1) to moveable drive plate 107. Furthermore, fixed drive plate 709 (FIG. 7) may be a single drive plate and, it does not need a slot through which rigid actuator arm 725 need protrude. Instead, walls 715 have a separation between them through which rigid actuator arm 725 may pass. Alternatively, those of ordinary skill in the art will readily recognize that a single wall with a slot or notch in it may be employed in lieu of walls 715.

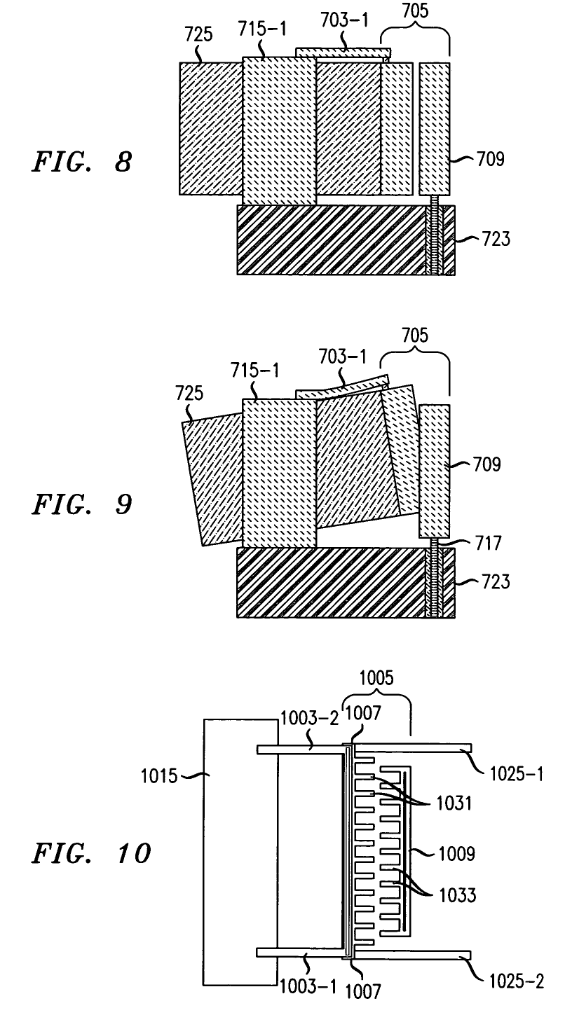

FIG. 8 shows a cross-section of structure 700 (FIG. 7) in the rest state, and FIG. 9 shows a cross-section of structure 700 (FIG. 7) when it is in an energized state.

FIG. 10 shows exemplary structure 1000, similar to structure 100 (FIG. 1) but in which rigid actuator arms 1025-1 (FIG. 10) and 1025-2 protrude from moveable drive plate 1007. Each of rigid actuator arms 1025-1 and 1025-2 flanks a respective side of fixed drive plate 1009. Note that fixed drive plate 1009 is similar to fixed drive plate 709 (FIG. 7), in that it does not need a slot to accommodate any rigid actuator arm. Exemplary structure 1000 may be useful in applications where it is necessary to simultaneously interrupt two beams at the same time.

Those of ordinary skill in the art will readily recognize that additional rigid actuator arms may be employed. One way that this may be achieved is by further extending moveable drive plate 1007 and having any such additional rigid actuator arms be further from the center of moveable drive plate 1007 than are rigid actuator arms 1025-1 and 1025-2. Another way that this may be achieved is by having additional rigid actuator arms closer to the center of moveable drive plate 1007, i.e., so that they are between rigid actuator arms 1025-1 and 1025-2. If this approach is employed, there will need to be slots in fixed drive plate 1009 through which such rigid actuator arms may move, or fixed drive plate 1009 will need to be made from multiple sections with a gap in between each section, such as is fixed drive plates 109 (FIG. 1).

Those of ordinary skill in the art will readily be able to fabricate devices such as are shown in FIGS. 1-10 using conventional processes such as those disclosed in my currently pending U.S. patent application Ser. No. 10/953,960 filed on Sep. 29, 2004.

What is claimed is:

1. An micro-electromechanical systems (MEMS) device, comprising
a plurality of spaced deformable spring bars, each of said deformable spring bars being suspended offset from a substrate;
a first moveable drive plate coupled to said deformable spring bars, said first moveable drive plate being adapted to rotate substantially about an axis that extends between a first and second one of said spring bars from a first point, at which said first spring bar couples to said first moveable drive plate, to a second point, at which said second spring bar couples to said first moveable drive plate; and
at least one rigid actuator arm extending from said first moveable drive plate.

2. The invention as defined in claim 1 further comprising a support structure coupled to said deformable string bars to keep said deformable spring bars offset from said substrate.

3. The invention as defined in claim 2 wherein said support structure is made up of a plurality of portions, and wherein said at least one rigid actuator arm passes between at least two of said portions.

4. The invention as defined in claim 2 wherein at least one rigid actuator is adapted to move out of the plane of said substrate when a potential difference is applied between said moveable drive plate and at least one fixed drive plate positioned oppositely to said moveable drive plate.

5. The invention as defined in claim 2 wherein at least one rigid actuator arm is adapted to move into the plane of said substrate when a potential difference is applied between said moveable drive plate and at least one fixed drive plate positioned oppositely to said moveable drive plate.

6. The invention as defined in claim 1 wherein said at least one rigid actuator arm extends, at one end thereof, from said first moveable drive plate.

7. The invention as defined in claim 1 further comprising a fixed drive plate made up of a plurality of portions, wherein said at least one rigid actuator arm passes between at least two of said portions.

8. The invention as defined in claim 1 further comprising a fixed drive plate unit made up of a plurality fixed drive plates, wherein said at least one rigid actuator arm passes between at least two of said fixed drive plates.

9. The invention as defined in claim 1 wherein said moveable drive plate has comb teeth protruding therefrom.

10. The invention as defined in claim 1 further comprising at least one fixed drive plate portion having comb teeth.

11. The invention as defined in claim 1 wherein said at least one rigid actuator arm is adapted to move out of the plane of said substrate.

12. The invention as defined in claim 1 wherein at least one of said deformable spring bars is straight.

13. The invention as defined in claim 1 wherein at least one of said deformable spring bars is shaped with at least one not straight portion.

14. The invention as defined in claim 1 wherein said deformable spring bars are parallel.

15. The invention as defined in claim 1 wherein said at least one rigid actuator arm is coupled to said moveable drive plate.

16. The invention as defined in claim 1 wherein said at least one rigid actuator arm is integral to said moveable drive plate.

17. Apparatus, comprising:
at least two deformable spring means;
support means suspending each of said deformable spring means offset from a base means; and
moveable drive plate means coupled to said deformable spring means and being held offset from said base means thereby, said moveable drive plate means having protruding therefrom a rigid actuator arm.

18. The invention as defined in claim 17 wherein said rigid actuator is an integral part of said moveable drive plate.

19. The invention as defined in claim 17 wherein said rigid actuator is coupled to said moveable drive plate.

20. Apparatus, comprising:
a moveable drive plate suspended offset from a substrate, said moveable drive plate being adapted to rotate substantially about an axis that passes therethrough when a potential difference is applied between said moveable drive plate and a fixed drive plate; and
a rigid actuator arm protruding from said moveable drive plate, said rigid actuator arm rotating, when said moveable drive plate rotates, essentially about an axis that is through the point of attachment of said rigid actuator arm to said moveable drive plate.

21. The invention as defined in claim 20 wherein said moveable drive plate is suspend offset from said substrate by at least one spring bar coupled to a support protruding from said substrate.

22. The invention as defined in claim 20 wherein said moveable drive plate is suspended offset from said substrate by at least one spring bar coupled to a support protruding from said substrate, said support having a slot therein through which said rigid actuator arm passes.

23. The invention as defined in claim 20 wherein said moveable drive plate is suspended offset from said substrate by at least two spring bars coupled to at least two respective supports protruding from said substrate, there being a gap between at least two of said at least two supports through which said rigid actuator arm passes.

24. The invention as defined in claim 20 further comprising at least a second rigid actuator arm, said actuator arms being arranged to flank said fixed drive plate.
